(19) United States
(12) Patent Application Publication
(10) Pub. No.: US 2019/0205062 A1
(43) Pub. Date: Jul. 4, 2019

(54) SOLID STATE DRIVE STREAM ALLOCATION AND MAPPING

(71) Applicant: Western Digital Technologies, Inc., San Jose, CA (US)

(72) Inventors: Chao SUN, San Jose, CA (US); Xinde HU, San Jose, CA (US); Minghai QIN, San Jose, CA (US); Dejan VUCINIC, San Jose, CA (US)

(21) Appl. No.: 15/862,024

(22) Filed: Jan. 4, 2018

(51) Int. Cl. G06F 3/06

(52) U.S. Cl. CPC G06F 3/0659; G06F 3/0679; G06F 3/0611

(57) ABSTRACT

A method is disclosed describing receiving a command to perform one of a write operation and a read operation for a memory arrangement, creating a number of hard streams to accept data, wherein the number of hard streams is less than or equal to a total number of streams that the memory arrangement may create, mapping data to the hard streams based upon a heat designation of the data, transferring data to the hard streams, the data transferred to the hard streams categorized based upon a heat value of the data and performing the one of the write operation and the read operation for the memory arrangement.

### FIELD OF THE DISCLOSURE

Aspects of the disclosure relate to solid state drive operation. More specifically, aspects of the disclosure relate to solid state drive stream generation, allocation and mapping arrangements and methods to accomplish the mapping arrangements.

### BACKGROUND INFORMATION

Solid state drives (SSD) store and retrieve data related to various files. When a solid state drive accesses data in a file, a stream of data is created during the processing of the data. As applications, such as programs, continually access more data on the solid state drive, greater and greater numbers of streams are needed for accessing needed data due to the inherent data access density variations even for a single program.

Solid state drives have a limited number of streams that can be created. After a maximum number of streams have been created, latency builds for the computer system that uses solid state drives as the various requests for data go unfulfilled because a maximum number of streams has been achieved.

Additional problems arise when solid state drives handle data that have different properties. Access to data is generally accomplished without knowing the type of data accessed and the properties of the data. Dynamic optimization of the resources of each stream cannot be accomplished such that correct optimization occurs. Problems also occur when specific data sections are accessed more often than other data sections. For data that is “hot”, accessed more frequently, such data does not get prioritized over other data, therefore, on a percentage basis, the data that is needed more frequently must wait for other “colder” data to be processed, reducing the efficiency of the overall process.

There is a need to be able to prioritize handling of data according to the number of uses of that data to reduce the overall latency of the computer system.

There is also a need to minimize latency for computer systems seeking to access information from a solid state drive.

There is an additional need to create alternative streams for a solid state drive such that creation of such streams is economical.

### SUMMARY

So that the manner in which the above recited features of the present disclosure can be understood in detail, a more particular description of the disclosure, briefly summarized below, may be had by reference to embodiments, some of which are illustrated in the appended drawings. It is to be noted that the appended drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one non-limiting embodiment, a method is disclosed comprising receiving a command to perform one of a write operation and a read operation for a memory arrangement, creating a number of hard streams to accept data, wherein the number of hard streams is less than or equal to a total number of streams that the solid state device may create, mapping data to the hard streams based upon a heat designation of the data, transferring data to the hard streams, the data transferred to the hard streams categorized based upon a heat value of the data and performing the one of the write operation and the read operation for the memory arrangement.

In another non-limiting embodiment, an arrangement is disclosed comprising means for receiving a command to perform one of a write operation and a read operation for a memory arrangement, means for creating a number of hard streams to accept data, wherein the number of hard streams is less than or equal to a total number of streams that the solid state device may create, means for mapping data to the hard streams based upon a heat designation of the data, means for transferring data to the hard streams, the data transferred to the hard streams categorized based upon a heat value of the data and means for performing the one of the write operation and the read operation for the memory arrangement.

In another non-limiting embodiment, a method is disclosed comprising receiving a command to perform one of a write operation and a read operation for a memory arrangement, creating a number of hard streams to accept data, wherein the number of hard streams is less than or equal to a total number of streams that a memory arrangement may create, querying a user for number of streams to be created, accepting a user input for the number of streams to be created, creating a number of streams for data to be processed according to the number of user number of streams to be created, segregating the number of stream for data based upon a heat designation of the data, mapping data to the hard streams through the number of streams created based upon the user input and based upon the heat designation of the data, transferring data to the hard streams, the data transferred to the hard streams categorized based upon a heat value of the data; and performing the one of the write operation and the read operation for the memory arrangement.

In another non-limiting embodiment, an arrangement is disclosed comprising means for receiving a command to perform one of a write operation and a read operation for a memory arrangement, means for creating a number of hard streams to accept data, wherein the number of hard streams is less than or equal to a total number of streams that a memory arrangement may create, means for querying a user for number of streams to be created, means for accepting a user input for the number of streams to be created, means for creating a number of streams for data to be processed according to the number of user number of streams to be created, means for segregating the number of stream for data based upon a heat designation of the data, means for mapping data to the hard streams through the number of streams created based upon the user input and based upon the heat designation of the data, means for transferring data to the hard streams, the data transferred to the hard streams categorized based upon a heat value of the data; and means for performing the one of the write operation and the read operation for the memory arrangement.

In one non-limiting embodiment, a method is described comprising receiving a command to perform an operation for a computer memory drive, creating a number of hard streams to accept data, wherein the number of hard streams is less than or equal to a total number of streams that the solid state drive may create, mapping data to the number of hard streams based upon a parameter of the data, transferring data to the hard streams, the data transferred to the hard streams categorized based upon the parameter and performing the operation for the computer memory drive.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a diagram of write streams S1, S2, S3 and S4 in a non-optimized configuration.

FIG. 2 is a diagram of write streams S1, S2, S3 and S4 in an optimized configuration.

FIG. 3 is a diagram of eight data streams mapped to four hard streams.

FIG. 4 is a diagram of five applications with six individual streams supported by a solid state drive, wherein the six individual streams are formed into three hard streams.

FIG. 5 is a diagram of die conflicts with multi-streams.

FIG. 6 is a diagram of a feature to enable a user to open more application streams that stream resources on a solid state drive.

FIG. 7 is an algorithm flow for stream creation flow activities.

FIG. 8 is a multi-tenant host scenario for assigning one or more streams, in one non-limiting embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim. Likewise, reference to “the disclosure” shall not be construed as a generalization of an inventive subject matter disclosed herein and shall not be considered to be an element or limitation of the appended claims except where explicitly recited in a claim.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details and that numerous variations or modifications from the described embodiments are possible. As used herein, the terms “above” and “below”, “up” and “down”, “upper” and “lower”, “upwardly” and “downwardly”, and other like terms indicating relative positions above or below a given point or element are used in this description to more clearly describe certain embodiments.

The aspects of the description apply to computers and more specifically, aspects of controlling computers or computer connected devices such that the devices perform in an optimal method of operation. The aspects described relate to a host that interacts with other devices, such as a data storage arrangement. Data storage arrangements may be, for example, solid state drives and other similar arrangements.

In the embodiments described, a data storage arrangement is connected to a host system through an interface. The host system, in the illustrated embodiment, is an enterprise computer or a server so the computer may transmit and receive data from a data storage arrangement. The function of the data storage arrangement is to accept and store data until the data is needed by a user or the host. The data storage arrangement may have to accept large bursts of data at a rapid pace, depending on the computer processes performed, therefore the data storage arrangement is configured with multiple memory units, formed into arrays, that provide for various states of usage. Dies may write data to the arrays, as necessary, to complete the memory storage functions.

Certain sections of the data storage arrangement may be configured of memory systems that provide for fast action (low latency) so that computer processes may be conducted at a rapid pace. Such low latency action may be accomplished by single layer cell memory configurations. If bulk amounts of data are required to be stored, multiple layer cell memory configurations are also present, such as triple level cell memory configurations. The data storage arrangement, with the specific arrays, may therefore be configured from single level or multi-level cell arrangements. The data storage arrangement may have an interface that allows the data storage arrangement to connect with the host and allow for synchronization of the host and the data storage arrangement. The interface may be a SATA compatible interface, as a non-limiting embodiment. The memory storage may have a configuration to allow for plug and play ability. Other types of interfaces may be used and as such the SATA compatible interface should not be considered limiting.

Auxiliary connections may be provided to the data storage arrangement to allow for additional options for inputting data directly to the data storage arrangement without interfacing with a host. Such direct input of data may be provided through placement of an integrated secure digital card to offload or copy data. Other auxiliary connections may be provided for additional input/output operations. Such connections may be USB 2.0, USB 3.0, Firewire or other hard wired configurations. Gigabit Ethernet interfaces and connections may also be used. The throttling capabilities of the memory arrangement, therefore, may be used in capacities where writing of data is necessary.

Internal software may be provided on the data storage arrangement to allow for efficient storage and read capability of data on the system. Such internal software may be used such that the data storage arrangement can be used as a portable media server to wirelessly stream media to a host or output device. Such output devices may include, but not be limited to, smart televisions, smart phones, stereo audio system. The internal software may also be provided such that the access of data may be performed by cloud applications designed for interface with the data storage arrangement.

The internal software of the data storage arrangement may also be configured to provide for security of the data storage arrangement. Safeguarding of material provided on the data storage arrangement prevents unauthorized access to sensitive information contained on the system. Such security may be in the form of password protection, such as a Wi-Fi password protection. In some embodiments, the data storage arrangement may be configured with software that allows the data storage arrangement to create a hardware lock. Such hardware locks may prevent access through a USB connection.

A controller is provided to control actions of the solid state drive as required by the host. The controller may also be configured to perform maintenance activities for the solid state drive to allow for efficient use. The controller may be provided with code that interfaces with the internal software of the solid state drive to allow the controller to perform the various functions required. The controller, for example, may interact with the dies of the solid state drive to allow for reading or writing of data to the solid state drive.

In the illustrated embodiment, data streams are created and supported in order to process the data within the stream at an efficient level. While stream support is significant for home based computers, stream support is an especially important feature in enterprise solid state drives. Stream support in enterprise solid state drive configurations are used to reduce write amplification. In the illustrated embodiments, the stream may be a sequential type or random type as non-limiting embodiments. As a result, a data block may be reclaimed/deallocated at the same time. Stream identification and creation should be generated intelligently in order to maximize efficiency.

Two techniques are described herein for creation of solid state drive stream creation and mapping. In the illustrated embodiments, a middleware/device driver arrangement and corresponding software are provided for monitoring a data temperature of each application steams. In non-limiting embodiments, each application may open one or more streams, like meta stream, log stream, data stream etc.

In a first embodiment, hard-streams may be created, wherein each hard stream indicates a data temperature granularity of the stream SSD support. For example, four (4) hard-streams may be created to handle hot, very warm, warm and cold data. The total number of hard-streams are always less or equal to the total number of streams SSD supports. These SSD streams are mapped to the hard-streams. For each hard-stream pool, the resource is optimized.

Resources may include SRAM, NAND flash over-provisioning etc. In the illustrated embodiment, the benefits of creation and use of a hard-stream is the additional capability added for resource allocation and optimization according to data property. With asymmetric resources, the overall write amplification, quality of service, latency, throughput, and endurance are improved.

In another embodiment, a technique is provided which enables the increase of the total number of application streams a SSD supports. This, in turn, lowers the overall SSD write amplification. Conventionally, application streams and SSD streams are one to one mapping. If applications open the total number of streams a SSD supports, then no more new stream from application may be opened. Stream creation may contain data with vastly different temperatures, consequently leading to poor performance. Data in different application streams may have the exact or very near same data properties. For example, application A and application B may both have metadata logging which is similarly hot. These metadata could be grouped together in a SSD stream when there are insufficient individual streams for all applications. In the instance when the solid state drive nearly runs out of streams or has achieved a maximum number of streams, applications may provide better granularity streams for their own data classification and SSD controller merges streams with similar data property into the same SSD stream. Finally, the lowest overall write amplification is achieved.

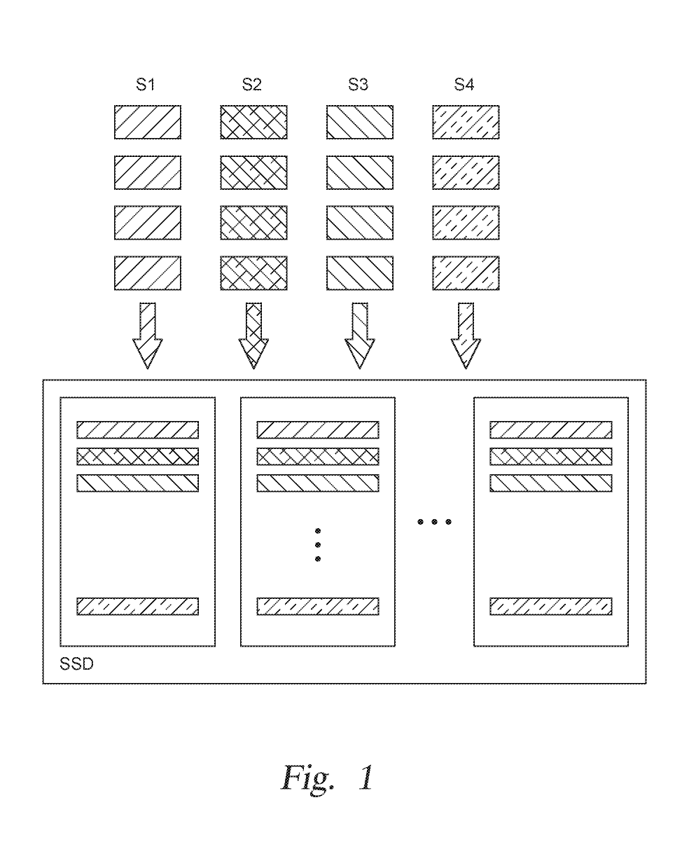

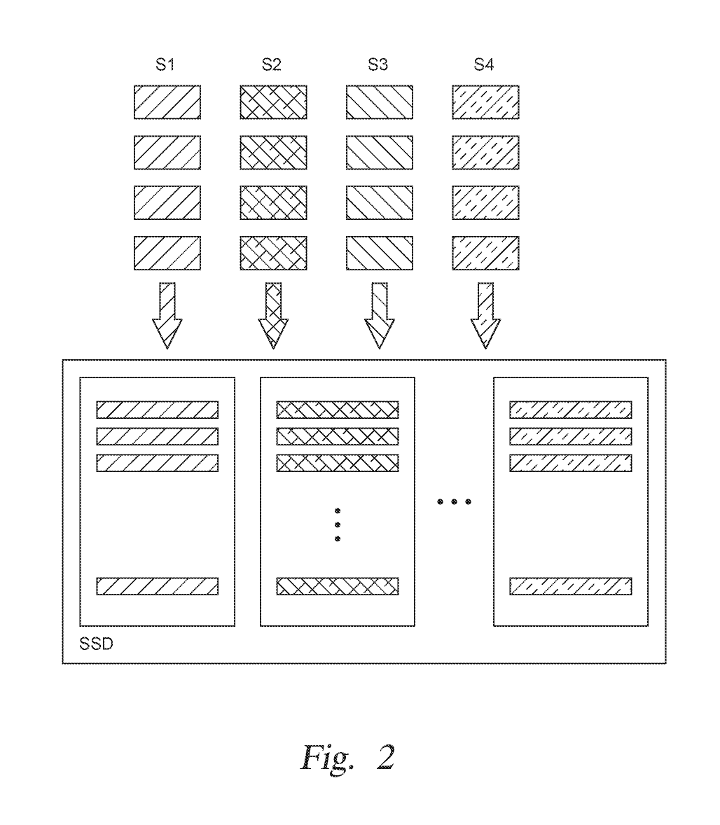

In non-limiting embodiments, the total number of streams that may be supported for an enterprise solid state drive is defined as S. The value S is limited due to resource constraints, such as random access memory (RAM), throughput/quality of service guarantees for each stream. It is desired to create a number of hard streams (HS). The number of hard streams must be less than or equal than the total number of streams S. In an instance when the number of hard streams (HS) is less than the total number of streams S, the individual streams of the total number of streams must be mapped to the hard streams. The number of hard streams (HS) is used to determine the granularity of general data activity classifications. For streams mapped to each of the individual hard streams, the resources like NAND flash over-provisioning may be allocated differently. Referring to FIG. 1, four different write streams S1, S2, S3 and S4 are provided. The coldest data is provided in S1 and then data that is progressively “hotter” is provided up to S4. Without write streams, data is mixed within the SSD, wherein cold data is mixed with hot data. Such mixing results in latency delays for the system. Referring to FIG. 2, with streams, data may be categorized according to their respective heat level, minimizing the overall latency. Although disclosed as using a “heat” level or index for the data, other data properties may be used for separation purposes.

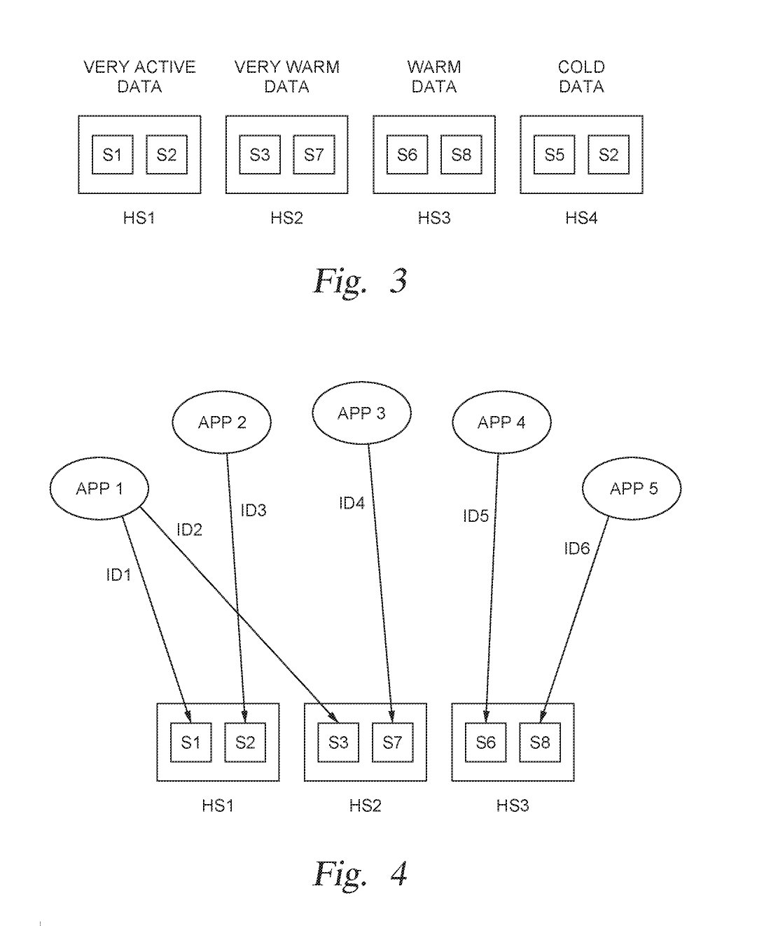

As illustrated in FIG. 3, four hard streams HS1, HS2, HS3 and HS4 are provided. Different data streams are mapped to the four (4) hard streams. In the illustrated embodiment provided in FIG. 3, individual streams S1 and S2 are mapped to hard stream HS1, individual streams S3 and S7 are mapped to hard stream HS2, individual streams S6 and S8 are mapped to hard stream HS3 and individual streams S5 and S2 are mapped to hard stream HS4. The hard streams themselves, contain data that is related to the temperature of the data. HS1, for example, contains data that is very active data (hot). Hard stream HS2 contains data that is defined as very warm data. Hard stream HS3 contains data that is warm and hard stream HS4 contains data that is cool or cold. The mapping, therefore, provides the most active data to the lower numbered hard streams and the data that is less active to the higher numbered streams. As a person of skill in the art will understand, such a configuration and mapping is merely illustrative and other configurations are possible.

Referring to FIG. 4, application streams and the corresponding mapping to hard streams is illustrated. In FIG. 4, five applications, namely App1, App2, App3, App4 and App5 are provided. Each of the application streams S1 to S6 are mapped to a specific hard stream. Identification names are provided to each of the application streams that are mapped to individual hard streams. As a non-limiting example, two streams originating from App1 are mapped to hard streams HS1 (S1) and HS2(S2) and are named ID1 and ID2 respectively. App2 has one stream S3 with a unique stream ID ID3 that maps to HS1. App3 has one stream S4 that is mapped to HS2 and provided with the unique stream ID ID4. App4 has one stream S5 that is mapped to HS3 and provided with the unique stream ID5. App5 has one stream S6 that is mapped to HS3 and provided with the unique stream ID6. The streams are mapped to solid state drive streams according to data temperature. Unique stream ID's ID1 and ID3, which have the hottest data, are mapped to hard stream HS1. The next hottest data belongs to unique ID2 and then ID4. ID2 and ID4 are therefore mapped to hard stream HS2. The coldest data ID5 and ID6 are mapped to HS3. As a result of the mapping, six (6) streams are mapped to three (3) hard streams. As will be apparent, having more or less numbers of hard streams will impact the mapping of which unique stream IDs go to which of the specific hard streams created.

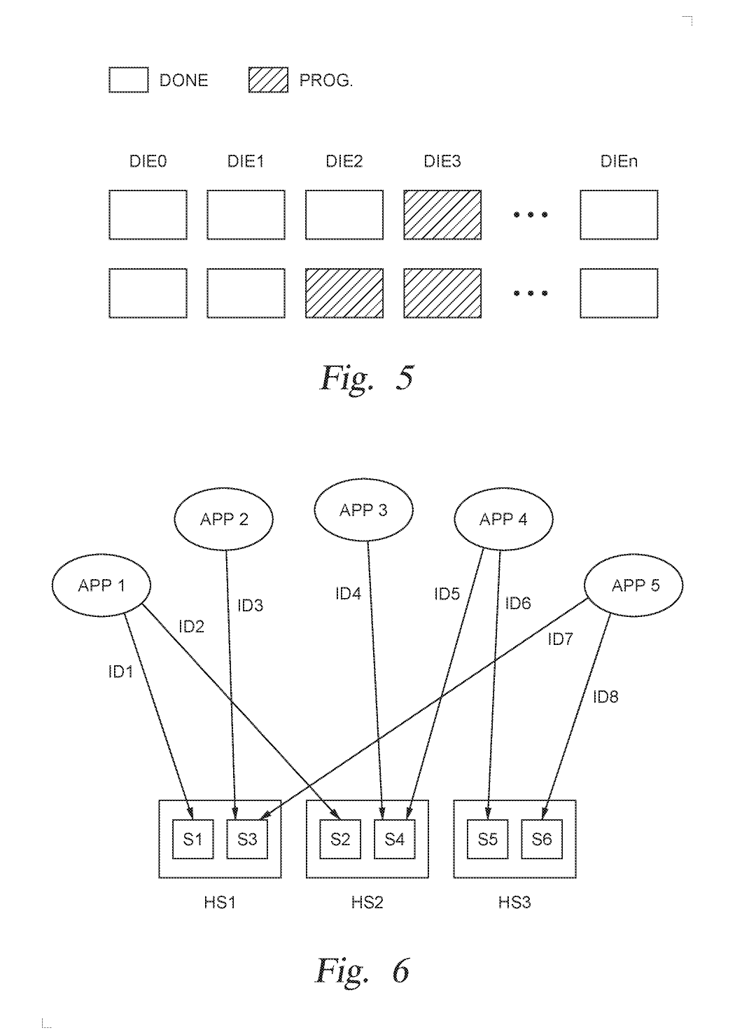

Referring to FIG. 5, die conflicts with multi-streams are illustrated. Die conflicts may be due, for example, to stream head speed variations. To reduce conflicts, more RAM may be used for buffering and XOR operations. For the column related to Die0, conflicts may be noted as “done”. For the column related to Die1, conflicts may be noted as “done”. For the column Die2, the first row is noted as “done” and the second row is noted as “prog”. For the column Die3, both the rows are noted as “prog”. For the Die/V column, each of the rows is noted as “done”.

Referring to FIG. 6, graph of applications streams and hard stream mapping is illustrated. Five applications are provided, namely App1, App2, App3, App4 and App5. In FIG. 6, the solid state drive controller may be used to classify streams and map them to stream resources. The granularity illustrated in FIG. 6, is much finer than in previous figures. Such a fine granularity results in a lower overall WAF. As provided in FIG. 6, users are provided with a feature that provides the ability to open more application streams than stream resources on a solid state drive by acknowledging that stream data isolation is not required. In the illustrated example, only six streams are supported by the solid state drive. Despite only six (6) streams being supported, a user is able to open more streams than originally supported by the solid state drive. The user has determined to open up two additional streams, a total of eight, with unique identification numbers ID1, ID2, ID3, ID4, ID5, ID6, ID7 and ID8. Three (3) hard streams are provided HS1, HS2 and HS3. The number of streams identified by the user are then mapped to the hard streams HS1, HS2 and HS3. The mapping, as provided in previous examples, is performed according to data temperature. The eight user enabled streams are then mapped to the six (6) SSD streams S1 through S6. Streams S1 and S3 are mapped to hard stream HS1, S2 and S4 are mapped to hard stream HS2 and S5 and S6 are mapped to hard stream HS3. Data temperature is measured for each of ID1 to ID8 and then mapped according to the respective temperature. In this specific example embodiment, ID1 is mapped to S1, ID2 is mapped to S2, ID3 is mapped to S3, ID4 is mapped to S4, ID5 is mapped to S4, ID6 is mapped to S5, ID7 is mapped to S3 and ID8 is mapped to S6.

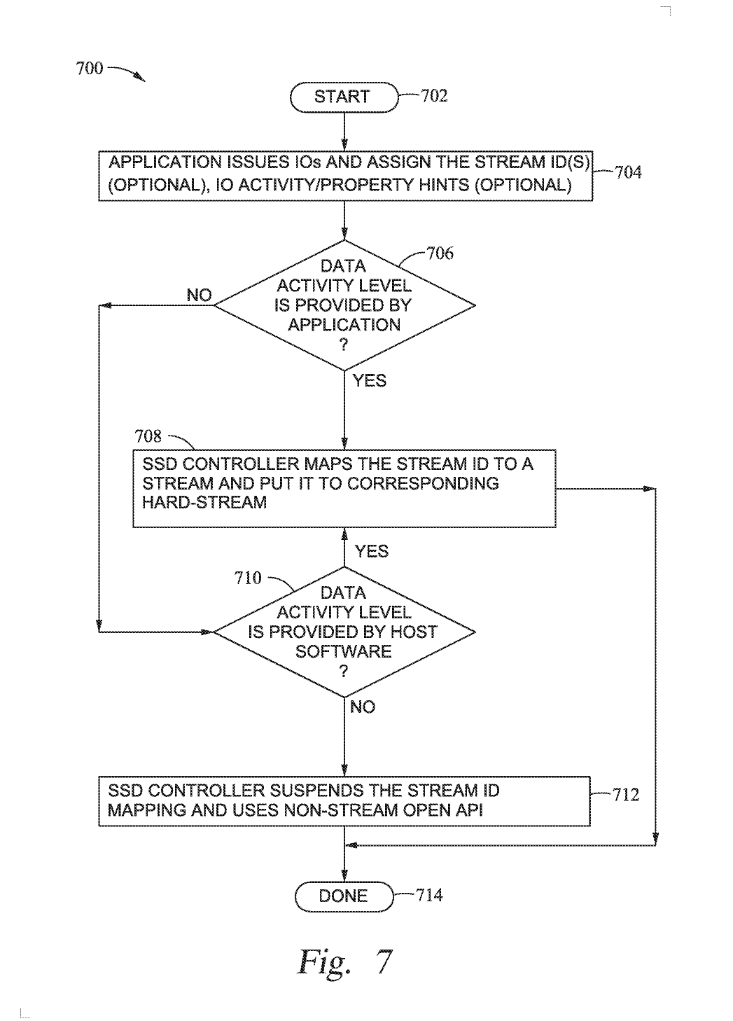

Referring to FIG. 7, in the illustrated embodiment, a method flow 700 is provided. The method starts at 702. At 704, an application issues IOs and assigns the stream ID(s) (optional), 10 activity/property hints (optional). At 706 a query is run where it is determined if data activity levels are provided by the application. If data activity levels are provided by the application at 706, then the SSD controller maps the stream ID to a stream and puts the stream ID to a corresponding hard stream at 708. The method then proceeds to 714. If the data activity level is not provided by the application at 706, then a query is run at 710 to determine if data activity levels are provided by host software. If data activity levels are provided by the host software, then the method continues to 708. If the data activity levels are not provided by host software at 710, then the SSD controller suspends the stream ID mapping and uses non-stream open API, with the method continuing to 714.

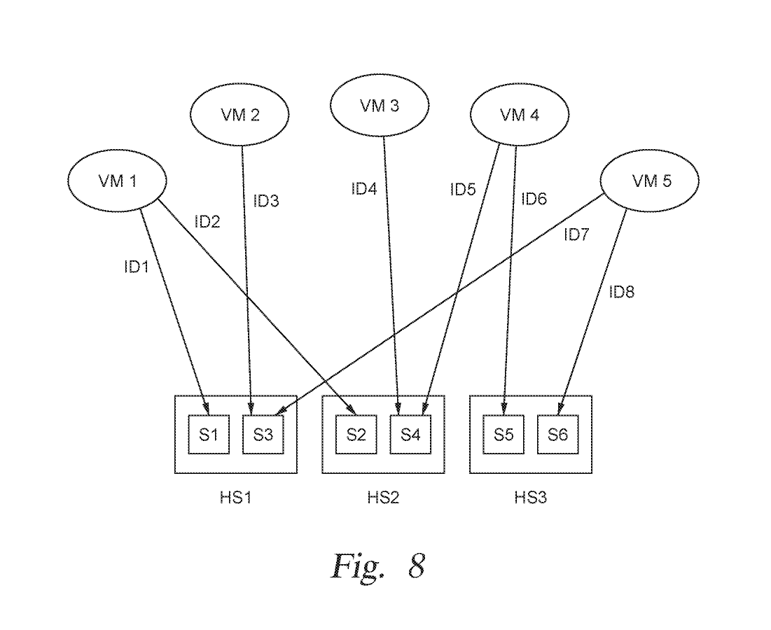

Referring to FIG. 8, a multi-tenant host scenario is illustrated. In this non-limiting embodiment, virtual machines (VM) may be provided to a solid state drive. Any number of virtual machines may be provided. In the illustrated embodiment five (5) virtual machines are illustrated. Each of the virtual machines may assign one or more streams. In this embodiment, instead of the “heat” of the data being assigned, differing lifetimes may be assigned to different streams. VM1 may have two unique streams ID1, mapped to S1 and ID2 mapped to S2. VM2 has one stream ID3 mapped to S3. VM3 has one stream ID4 mapped to S4. VM4 has two streams ID5 and ID6 mapped to S4 and S5. VM5 has two streams ID7 and ID8 mapped to S3 and S6 respectively. The differentiator, therefore, may be lifetime age of the data, rather than a “heat” of the data. Other data parameters may also be used and the use of age and heat should not be considered limiting.

The aspects described may also have application to automotive uses. In non-limiting embodiments, host side streaming hints/unique identifiers may be used to guarantee specific latencies and/or quality of service. For quality of service workloads, these workloads may be mapped to hard streams with more over provisioning. If workloads are not ideal, the WAF is greater than 1. Increasing over-provisioning, in specific embodiments, may reduce the average WAF and improve quality of service.

Different applications of hard stream materials may be extended to hybrid solid state device cases. In non-limiting embodiments, storage class memory capacity may be used. Storage class memory may be divided into a value M hard streams and NAND capacity may be dived into N hard streams. Latency sensitive workloads may be staged into of M storage class memory hard streams and destaged to NAND flash at the backend when necessary.

In one non-limiting embodiment, a method is disclosed comprising receiving a command to perform one of a write operation and a read operation for a memory arrangement, creating a number of hard streams to accept data, wherein the number of hard streams is less than or equal to a total number of streams that the memory arrangement may create, mapping data to the hard streams based upon a heat designation of the data, transferring data to the hard streams, the data transferred to the hard streams categorized based upon a heat value of the data and performing the one of the write operation and the read operation for the memory arrangement.

In one non-limiting embodiment, the method is performed wherein the transferring of the data to the hard streams is performed by a controller.

In one non-limiting embodiment, the method is performed wherein the controller is a component of a solid state drive.

In another non-limiting embodiment, the method may be accomplished wherein the creating of the number of hard streams is user defined.

In another non-limiting embodiment, the method may further comprise reading data to be mapped to the hard streams.

In another non-limiting embodiment, the method may further comprise segregating the data that is read according to the heat value.

In another non-limiting embodiment, the method may further comprise segregating the data that is read according to a data age.

In a further non-limiting embodiment, the method may be performed wherein the memory arrangement is a hybrid drive.

In another non-limiting embodiment, an arrangement is disclosed comprising means for receiving a command to perform one of a write operation and a read operation for a memory arrangement, means for creating a number of hard streams to accept data, wherein the number of hard streams is less than or equal to a total number of streams that the solid state device may create, means for mapping data to the hard streams based upon a heat designation of the data, means for transferring data to the hard streams, the data transferred to the hard streams categorized based upon a heat value of the data and means for performing the one of the write operation and the read operation for the memory arrangement.

In another non-limiting embodiment, the arrangement may further comprise means for reading data to be mapped to the hard streams.

In a still further embodiment, the arrangement may further comprise means for segregating the data that is read according to the heat value.

In another embodiment, a method is described comprising receiving a command to perform one of a write operation and a read operation for a memory arrangement, creating a number of hard streams to accept data, wherein the number of hard streams is less than or equal to a total number of streams that a memory arrangement may create, querying a user for number of streams to be created, accepting a user input for the number of streams to be created, creating a number of streams for data to be processed according to the number of user number of streams to be created, segregating the number of stream for data based upon a heat designation of the data, mapping data to the hard streams through the number of streams created based upon the user input and based upon the heat designation of the data, transferring data to the hard streams, the data transferred to the hard streams categorized based upon a heat value of the data and performing the one of the write operation and the read operation for the memory arrangement.

In another non-limiting embodiment, the method may be accomplished wherein the transferring of the data to the hard streams is performed by a controller.

In another non-limiting embodiment, the method may be accomplished wherein the controller is a component of a solid state drive.

In another non-limiting embodiment, the method may be accomplished wherein the memory arrangement is a hybrid drive.

In another non-limiting embodiment, an arrangement is disclosed comprising means for receiving a command to perform one of a write operation and a read operation for a memory arrangement, means for creating a number of hard streams to accept data, wherein the number of hard streams is less than or equal to a total number of streams that a memory arrangement may create, means for querying a user for number of streams to be created, means for accepting a user input for the number of streams to be created, means for creating a number of streams for data to be processed according to the number of user number of streams to be created, means for segregating the number of stream for data based upon a heat designation of the data, means for mapping data to the hard streams through the number of streams created based upon the user input and based upon the heat designation of the data, means for transferring data to the hard streams, the data transferred to the hard streams categorized based upon a heat value of the data and means for performing the one of the write operation and the read operation for the memory arrangement.

In another non-limiting embodiment, a method is disclosed comprising receiving a command to perform an operation for a computer memory drive, creating a number of hard streams to accept data, wherein the number of hard streams is less than or equal to a total number of streams that the solid state drive may create, mapping data to the number of hard streams based upon a parameter of the data, transferring data to the hard streams, the data transferred to the hard streams categorized based upon the parameter and performing the operation for the computer memory drive.

In another non-limiting embodiment, the method may be accomplished wherein the parameter of the data is one of a data heat and a data age.

In another non-limiting embodiment, the method may be accomplished wherein the operation for the solid state drive is one of a write operation and read operation.

In another non-limiting embodiment, the method may be accomplished wherein the computer memory drive is a solid state drive.

While embodiments have been described herein, those skilled in the art, having benefit of this disclosure will appreciate that other embodiments are envisioned that do not depart from the inventive scope of the present application. Accordingly, the scope of the present claims or any subsequent related claims shall not be unduly limited by the description of the embodiments described herein.

1. A method, comprising:
receiving a command to perform one of a write operation and a read operation for a memory arrangement;
creating a number of hard streams to accept data, wherein the number of hard streams is less than or equal to a total number of streams that the memory arrangement may create;
mapping data to the hard streams from the one write operation and read operation based upon a heat designation of the data, wherein the data is mixed with different heat designations;
transferring data directly to the hard streams from the one write operation and read operation, the data transferred to the hard streams categorized based upon a heat value of the data; and
performing the one of the write operation and the read operation for the memory arrangement.

2. The method according to claim 1, wherein the transferring of the data to the hard streams is performed by a controller.

3. The method according to claim 2, wherein the controller is a component of a solid state drive.

4. The method according to claim 1, wherein the creating of the number of hard streams is user defined.

5. The method according to claim 1, further comprising:
reading data to be mapped to the hard streams.

6. The method according to claim 5, further comprising:
segregating the data that is read according to the heat value.

7. The method according to claim 5, further comprising:
segregating the data that is read according to a data age.

8. The method according to claim 1, wherein the memory arrangement is a hybrid drive.

9. An arrangement, comprising:
means for receiving a command to perform one of a write operation and a read operation for a memory arrangement;
means for creating a number of hard streams to accept data, wherein the number of hard streams is less than or equal to a total number of streams that a solid state device may create;
means for mapping data to the hard streams from the one write operation and read operation based upon a heat designation of the data, wherein the data is mixed with different heat designations;
means for transferring data directly to the hard streams from the one write operation and read operation, the data transferred to the hard streams categorized based upon a heat value of the data; and
means for performing the one of the write operation and the read operation for the memory arrangement.

10. The arrangement according to claim 9, further comprising:
means for reading data to be mapped to the hard streams.

11. The arrangement according to claim 9, further comprising:
means for segregating the data that is read according to the heat value.

12. A method, comprising:
receiving a command to perform one of a write operation and a read operation for a memory arrangement;
creating a number of hard streams to accept data, wherein the number of hard streams is less than or equal to a total number of streams that a memory arrangement may create;
querying a user for number of streams to be created;
accepting a user input for the number of streams to be created;
creating a number of streams for data to be processed according to the user input for the number of streams to be created;
segregating the number of stream for data based upon a heat designation of the data wherein the data is mixed with different heat designations;
mapping data directly to the hard streams through the number of streams created based upon the user input and based upon the heat designation of the data;
transferring data directly to the hard streams, the data transferred to the hard streams categorized based upon a heat value of the data; and
performing the one of the write operation and the read operation for the memory arrangement.

13. The method according to claim 12, wherein the transferring of the data to the hard streams is performed by a controller.

14. The method according to claim 13, wherein the controller is a component of a solid state drive.

15. The method according to claim 12, wherein the memory arrangement is a hybrid drive.

16. An arrangement, comprising:
means for receiving a command to perform one of a write operation and a read operation for a memory arrangement;
means for creating a number of hard streams to accept data, wherein the number of hard streams is less than or equal to a total number of streams that a memory arrangement may create;
means for querying a user for number of streams to be created;
means for accepting a user input for the number of streams to be created;
means for creating a number of streams for data to be processed according to the user input for the number streams to be created;
means for segregating the number of stream for data based upon a heat designation of the data;
means for mapping data from the one write operation and read operation to the hard streams through the number of streams created based upon the user input and based upon the heat designation of the data wherein the data is mixed with different heat designations;
means for transferring data to the hard streams, the data transferred to the hard streams categorized based upon a heat value of the data; and
means for performing the one of the write operation and the read operation for the memory arrangement.

17. A method, comprising:
receiving a command to perform an operation for a computer memory drive;
creating a number of hard streams to accept data, wherein the number of hard streams is less than or equal to a total number of streams that a solid state drive may create;
mapping data to the number of hard streams based upon a heat of the data, wherein the heat of the data is mixed;
transferring data directly to the hard streams, the data transferred to the hard streams categorized based upon the heat; and
performing the operation for the computer memory drive.

18. (canceled)

19. The method according to claim 17, wherein the operation for the solid state drive is one of a write operation and read operation.

20. The method according to claim 17, wherein the computer memory drive is a solid state drive.

21. The method according to claim 17, wherein the method is performed in an automobile.

22. The method according to claim 17, wherein the receiving of the command is performed by a virtual machine.
